(19) United States
(12) Patent Application Publication
(10) Pub. No.: US 2026/0015256 A1
(43) Pub. Date: Jan. 15, 2026

(54) METHOD AND SYSTEM FOR PURIFICATION OF FEED LIQUID

(71) Applicant: OY INFRACONSULTING AB LTD, Vantaa (FI)

(72) Inventors: Wladimir LJAPIDEVSKIJ, Espoo (FI); Tom ALBRECHT, Vantaa (FI); Markus KANKAANPÄÄ, Vantaa (FI)

(73) Assignee: OY INFRACONSULTING AB LTD, Vantaa (FI)

(21) Appl. No.: 18/881,128

(22) PCT Filed: Jul. 6, 2023
(86) PCT No.: PCT/FI2023/050432

§ 371 Date: Jan. 3, 2025

(30) Foreign Application Priority Data
Jul. 18, 2022 (FI) 20225677

(51) Int. Cl. C02F 1/22

(52) U.S. Cl. CPC C02F 1/22; C02F 2209/02; C02F 2209/03; C02F 2209/05; C02F 2209/40; C02F 2301/066

(57) ABSTRACT

A method for purification of feed liquid containing minerals or chemicals or both, having steps of
feeding feed liquid into a tank and pressurizing the feed liquid to a high pressure using a piston extending partially outside the tank, the piston being attached to an actuator located at least outside the tank for pushing and pulling the piston,
cooling the feed liquid near freezing point;
expanding the feed liquid adiabatically to essentially normal pressure forming a mixture of ice and liquid brine;
removing and collecting the liquid brine;
feeding product liquid forming a second mixture of ice and product liquid;
pressurizing the second mixture to high pressure;
using the second mixture to cool feed liquid under high pressure expanding the second mixture adiabatically to essentially normal pressure; and
removing the second mixture from the tank as the product liquid.

### FIELD

The invention relates to a method for purification of feed liquid, the feed liquid containing minerals or chemicals or both, the method having the followings steps of:
feeding feed liquid into a tank,
pressurizing the feed liquid in the tank to a high pressure,
cooling the feed liquid at high pressure using heat transfer liquid to temperature near freezing point under said high pressure,
expanding the feed liquid adiabatically in the tank to essentially normal pressure causing at least a part of the feed liquid to freeze forming a mixture of ice and liquid brine,
removing the liquid brine from the tank,
feeding product liquid into the tank forming a second mixture of ice and product liquid, pressurizing the second mixture adiabatically to high pressure causing the ice to melt,
using the second mixture to cool another portion of pressurized feed liquid under high pressure thus expanding the second mixture adiabatically to essentially normal pressure,
removing the second mixture from the tank as the product liquid.

The invention also relates to a system for purification of feed liquid.

### BACKGROUND

The known desalination technology is based on surface processes; in the distillation methods this involves evaporation and condensation, while in reverse osmosis the process water is forced through membranes with pressure. These surface processes require large, expensive structures and the extra energy needed to maintain the speed of the process leads to their low thermodynamic efficiency.

The Master's thesis of Ulla Oksanen, “Adiabatic freeze desalination process”, Tampere University of Technology, February 2014, discloses a desalination process, in which the critical separation process, freezing of water, takes place adiabatically, without exchange of heat, by means of a pressure change. This is a volume process that is free from the above drawbacks. In this process pretreated process feed water is brought adiabatically to a high pressure, of the order of 10 to 200 MPa, and pressurized feed water is cooled to a temperature close to the freezing point of said water under said pressure. The process feed water is salty and/or mineral rich liquid containing for example Ca-, Na-, Cl-, Mg-, metal sulfates and hydroxides. The cooled feed water is expanded adiabatically to normal pressure while a part of it freezes, forming a mixture of pure ice and liquid brine, and the liquid brine is removed and replaced with pure product fresh water.

The liquid brine is removed and replaced with pure product water, the mixture of ice and liquid product water is returned to a high pressure, of the order of 100 to 200 MPa, causing the ice to melt and cool said liquid process water, and the cooled liquid process water is used to cool another portion of pressurized water. Finally, the warmed liquid process water is expanded adiabatically to normal pressure and allowed to exit as pure product water.

The theoretical energy demand of the process depends on the salt concentration of the feed water and the rate of water recovery, i.e., the degree of concentration of the brine rejected. The situation is illustrated in Fig. In the case of sea water, the salt concentration is close to 35 kg/L and the theoretical energy cost of the product is ca. 1 kWh/m³ at a recovery of 50%.

The practical energy cost of a desalination process is dominated by the degree of reversibility of the operations involved. It is necessary to freeze the part of the process water that is recovered. The latent heat of fusion of water is 333.7 KJ/kg=92.7 kWh/m³. This gives freezing processes an advantage over distillation processes where the heat of evaporation is ca. 700 kWh/m³; for good efficiency even the heat of freezing must be conserved and handled quite close to reversibility.

However, the above-mentioned thesis fails to disclose a real-life implementation of such desalination process.

Publication JP S48-17432 B1 is also known from the prior art. It discloses a system that utilizes a pair of tanks connected to each other each tank having a diaphragm inside for pressurizing the tank by using hydraulic pressure and a freely moving piston inside the tank. However, this kind of system is not reliable due to the use of diaphragm with high pressure. In addition, the control of this kind of system is difficult as the position of the piston is hard to monitor.

### SUMMARY

The aspects of the disclosed embodiments are directed to providing a method capable of real-life implementation of the known purification process and to improve the usability of the method and the system to a wider range of feed liquids besides salty water

The aspects of the disclosed embodiments are characterized by a method for purification of feed liquid containing minerals or chemicals or both, the method having the followings steps of feeding feed liquid into a tank, pressurizing the feed liquid in the tank to a high pressure, and cooling the feed liquid at high pressure using heat transfer liquid to temperature near freezing point under said high pressure. The method further includes steps of expanding the feed liquid adiabatically in the tank to essentially normal pressure causing at least a part of the feed liquid to freeze forming a mixture of ice and liquid brine, removing the liquid brine from the tank and the collecting the brine. In addition, the method includes steps of feeding product liquid into the tank forming a second mixture of ice and product liquid, pressurizing the second mixture adiabatically to high pressure causing the ice to melt, using the second mixture to cool another portion of pressurized feed liquid under high pressure thus expanding the second mixture adiabatically to normal pressure and removing the second mixture from the tank as the product liquid. The tank is pressurized and expanded by using a piston extending partially outside the tank, the piston being attached to an actuator located at least outside the tank for pushing and pulling the piston, the piston affecting the volume of the tank.

The method according to the disclosed embodiments utilizes the fact that the energy needed for cooling the feed liquid near the point of freezing at high pressure is significantly less than the energy needed for the same temperature change in normal pressure. In addition, the use of adiabatic expansion for causing the freezing of the feed liquid is much more energy efficient than using external cooling past the freezing point. By using the hydraulic cylinder for the volume change of the tank, the method can be implemented reliably and cost efficiently. The novelty of disclosed embodiments is also that the brine is recovered and collected as a valuable product along with the product liquid which might be pure water. Thus, the disclosed embodiments are usable for a wide variety of different implementations from recovering valuable minerals or chemicals or both from industrial effluents to purification of salty water for human consumption.

Preferably the tank has a single uniform volume for the feed liquid that is used for the steps. In other words, there is no diaphragms or membrane or other partitioning of the interior volume of the tank which makes the tank robust and easy to manufacture.

The method may further include a step of recycling the brine at least once, preferably 2-10 times, most preferably 4-8 times to the tank as feed liquid to increase the concentration of the brine. By recycling the brine more water can be removed from the brine thus increasing the concentration of the brine for further use.

Preferably the product liquid is water and pure ice is formed during adiabatic expansion of the feed liquid. The expansion of the water during freezing improves the energy efficiency of the method. However, the method can also be used for other liquids or solutions with a similar type of anomality to expand during freezing.

Preferably the method further includes a step of collecting the pressure energy during expansion in the tank into a pressure accumulator using the piston connected to the pressure accumulator. This improves the energy efficiency of the method as approximately half of the expansion pressure energy can be reused for pressurization of feed liquid or second mixture along with a half of primary energy. Assuming constant compressibility of water, the work W required to pressurize water to pressure p is W=½ p², where is the compressibility of water (bar⁻¹) and p is pressure in bar. Actually, the compressibility of water decreases nearly linearly with pressure; at 0° C. and normal pressure=52·10⁻⁶/bar. At 2000 bar=29·10⁻⁶/bar.

The analysis disclosed in the Thesis of Oksanen uses a cycle with a maximum pressure of 1970 bar and a minimum temperature of −200° C. For water compressibility its value at 1000 bar, 38.7·10⁻⁶ bar, is used. The water compression work at 0° C. was found to be 7.51 MJ/kg or 2.09 kwh/m³. 54% of the water will freeze in an adiabatic decompression starting at 1970 bar at −20° C. and ending at 1 bar, 0° C.

Preferably the method further includes a step of detecting the formation of ice by a sensor based on pressure change in the tank during expansion and using software to drive the piston to compensate the change of pressure caused by the forming of ice. By compensating the change of pressure in the tank caused by the formation of ice the pressure levels can be maintained at an optimal curve keeping the water as ice during adiabatic expansion. The sensor may also be used to detect undesired crystallization of minerals, so that it can be avoided to avoid solids buildup in the tank.

According to an embodiment the feed liquid can be lime slurry used, for example, in mines for minerals used in batteries, gold mines or such. In these types of industrial processes lime is used to adjust the pH of the liquids. For example, the lime slurry of gold mines may include low concentrations of titanium, which could be recovered using the method according to the disclosed embodiments.

Preferably the method further includes a step of heating the pressurized second mixture using the heat of the heat transfer liquid used for cooling of the pressurized feed liquid. This improves the energy efficiency of the method.

According to an embodiment the method further includes a step of utilizing two tanks with common heat exchange system. By utilizing two tanks side by side heat can be transferred between the two tanks, which are preferably at different phases of the purification process.

The method may further include a step of pressurizing the feed liquid and the second mixture to a high pressure of 5-200 MPa, preferably to 15-150 MPa, most preferably 60-100 MPa. With these pressure levels the amount of energy needed to cool the pressurized feed liquid near freezing is significantly smaller than on normal pressure and at the same time the tanks may be implemented using ordinary technology of pressure vessels without any extraordinary measures.

According to an embodiment the method further includes a step of introducing a freezing initiation impulse of at the beginning of expansion of the cooled and pressurized feed liquid to initiate the freezing of the feed liquid. As with effluents the initiation of freezing may be hard to predict, as in some cases the feed liquid may become subcooled before freezing, the freezing may be timely initiated by a separate impulse. The precise beginning of freezing facilitates the automation of the method and system.

Preferably the ice formed during adiabatic expansion is pure ice and the product is then pure water. The definition of pure in this case refers to essentially pure in the sense that it does not contain any significant amounts of impurities. However, the meaning of pure water does not refer to water that is necessarily pure enough for human consumption. This may need further purification steps of other sorts.

The freezing initiation impulse may be created by mechanical input, pressure impact or by energy impact. Most preferably cold is fed inside the tank. The feeding of cold may include an insertion of a cold probe into tank.

Alternatively, an ultrasonic probe may be used for creating the freezing initiation impulse. The ultrasonic probe may be located outside the tank, which means that there is no need for any sealing between the probe and the tank.

Preferably the adiabatic expansion of the feed liquid in the tank is controlled using a control algorithm to maintain the feed liquid in liquid crystallization phase of freezing. In other words, during expansion the freezing of the feed liquid is controlled in such a manner.

During expansion, the control algorithm is arranged to control the freezing of feed liquid and composition at a desired controlled rate while maintaining separation of brine and product so that brine is in as pure a form as possible while remaining at crystallization phase using sensor information including one or more of the following: piston stroke length, volume, fluid conductivity, fluid density, activity coefficient; for control.

Preferable the control algorithm uses sensor to monitor information including one or more of the following: piston stroke length, volume, fluid conductivity, fluid density, activity coefficient; and based on the information controls the movement of the piston during expansion to maintain the crystallization of the feed liquid within ±30%, preferably within ±10% range of the temperature and pressure of the eutectic point of the feed liquid. By maintaining the expansion and the freezing of feed liquid at the eutectic point or at least close to it, the purity of the ice can be improved and thus the efficiency of the process.

Preferably the control algorithm maintains the feed liquid in liquid crystallization phase of freezing while the piston is moving until the movement of the piston stops when the ice is formed. The duration of freezing improves the purity of ice. However, if the duration of the expansion is long, the capacity of the process may suffer. It is possible to achieve better purity by either increasing the duration of the expansion or by recycling the brine back to the tank, whichever is the most effective when considering the process at an economical standpoint.

The duration of the expansion can be 1 s-2 h, preferably 2 s-20 min. The purity of ice tends to increase by using a longer time for the expansion for simple salts, for example NaCl, that are feed liquids in the process.

Each feed liquid has its own eutectic point, which is characteristic to that feed liquid. Preferably a rough estimate for each feed liquid can be attained by simulation of the expansion, for example by using Ansys Fluent-software. This software is a general-purpose computational fluid dynamics (CFD) software used to model fluid flow, heat and mass transfer, and chemical reactions.

The aspects of the disclosed embodiments are directed to providing a system capable of real-life implementation of the known purification process and to improve the usability of the method and the system to a wider range of feed liquids besides salty water. The aspects of the disclosed embodiments are characterized by a system for purification of feed liquid containing minerals, the system comprising a tank, an inlet and a pump for feeding the feed liquid into the tank, and a piston in connection with the tank for affecting volume of the tank to pressurize and depressurize the tank alternatively to essentially normal pressure causing at least a part of the feed liquid to freeze forming a mixture of ice and liquid brine, the piston extending at least partially outside the tank and being attached to an actuator located outside the tank for pushing and pulling the piston. In addition, the system includes a heat exchange system with heat transfer liquid arranged in connection with the tank for alternatively cooling the feed liquid at high pressure in the tank and heating a second mixture of ice and liquid product in the tank using the heat transfer liquid, an outlet for removing the liquid brine and product liquid alternatively from the tank, a brine tank for recovering and collecting the brine, a product liquid tank for recovering the liquid product and a recycle system for recycling product liquid into the tank forming a second mixture of ice and product liquid.

With the use of a hydraulic driven piston to cause the adiabatic expansion and pressurization of the tank the system can be implement in such a manner that it can be easily adapted to different types of feed liquids, such a salty sea water, waste waters of mines and quarries, and other type of industrial effluent containing valuable minerals. Previously purification process has mainly been used for purification of salty water for human consumption wherein the salty brine has been practically worthless. Now the system according to the disclosed embodiments can be used to recover valuable minerals that can be recycled back to use without using expensive and large evaporation columns. The investment and running costs of mineral recovery can be decreased drastically as the system according to the disclosed embodiments is very energy efficient compared to evaporation-based processes.

Preferably the actuator is a hydraulic cylinder fixedly attached to the piston for both pushing and pulling the piston. With the aid of the hydraulic cylinder, the piston affecting the volume of the tank can be moved in both directions, i.e. pulled and pushed for compression and expansion.

Alternatively, the actuator can be an electric motor. However, the electric motor does not allow the piston to move backwards to adjust to the expansion caused by the formation of ice in the tank.

The system preferably includes two wear rings located at a distance from each other placed in between the piston and the tank for supporting the piston, and at least one piston ring around the piston for sealing the piston. With these wear rings and the piston ring, the piston can be reliably sealed in the tank which is important when handling feed liquid in high pressures. The feed liquids may also contain abrasive solids.

The piston ring preferably has a metal reinforcement. The metal reinforcement makes the piston ring rigid and locks the seal in place. The piston ring can also be called as the piston seal.

According to first embodiment, the system includes a piston sleeve and an outer sleeve placed concentrically relative to each other between the piston and the tank, and each of the piston sleeve and the outer sleeve having one of the wear rings.

According to a second embodiment the system includes hydraulic connection line between the piston and the tank, wherein the hydraulic connection line forms part of the volume of the tank and the piston is located at least partially inside the hydraulic connection line and the piston is attached to the actuator, both piston and actuator located at the side of the tank. This kind of implementation enables the combination of the actuator, piston and tank to be smaller in height compared to the first embodiment wherein the actuator, piston and the tank are all concentric, one after the other.

According to an embodiment the piston extends partially inside the tank. Thus, the tank provides support for the piston.

Preferably the system further includes a pressure accumulator for collecting pressure energy during expansion in the tank using the piston. Thus, a part of the pressure energy during expansion can be recovered by pressurizing the pressure accumulator using the opposite side chamber of the piston.

Preferably the system further includes a sensor for detecting the formation of ice based on pressure change in the tank during expansion, and software for driving the piston to compensate the change of pressure caused by the forming of ice. It has been noticed during experiments that industrial effluent such as lime, tends to go beyond the theoretical freezing point during expansion before forming ice. This makes it more difficult to maintain pressure at desired curve during expansion. For industrial scale implementation the system must be able to be automized to great extent which would be very difficult unless the actual formation of time could not be observed reliably. Now with the aid of the sensor the point of formation of ice can be detected and used for control of the piston for compensation of the pressure increase.

According to an embodiment the system includes two tanks with common heat exchange system. By using two tanks preferably in opposite phases of the process the heat recovered from cooling the feed liquid at high pressure in one tank can be utilized for heating the second mixture of ice and product liquid of another tank. A scaleup of capacity of the system can be implemented using multiple sets of two tanks, for example, 8 or 12 tanks in total.

The hydraulic driven piston and the tank are preferably arranged to be used with a high pressure of 5-200 MPa, preferably to 15-150 MPa, most preferably 60-100 MPa. The use of high pressure reduces the amount of heat transfer for cooling and thus improves the thermal efficiency of the process. However, the increase of pressure above the ranges disclosed above could cause large costs for implementation of the tanks.

In the system according to the disclosed embodiments preferably only the tank or tanks, the piping and the connecting valves to tank(s) are at high pressure, the remainder of the system is at essentially normal pressure which reduces the implementation costs of the system.

Preferably the system includes a sensor for monitoring information including one or more of the following: piston stroke length, volume, fluid conductivity, fluid density, activity coefficient; and a control unit with software including a control algorithm arranged to control the movement of the piston 90 during expansion based on the measured sensor information to maintain the crystallization of the feed liquid within ±30%, preferably within ±10% range of the temperature and pressure of the eutectic point of the feed liquid.

With the method and system according to the disclosed embodiments it is possible to desalinate liquids very energy-efficiently as a substitute for an evaporation process, which in prior art has been used for desalination and other feed liquid purification. The use of the method and system according to the disclosed embodiments saves both energy and investment costs as the system is very affordable to implement and does not require expensive auxiliary equipment such a steam plant or steam regeneration facilities.

### BRIEF DESCRIPTION OF THE DRAWINGS

In the following, the disclosed embodiments is described in detail with reference to the accompanying drawings showing some applications of the disclosed embodiments, in which

FIG. 1 shows the theoretical separation energy of desalination processes as a function of the recovery rate,

FIG. 2 shows basic view of an embodiment of the system according to the disclosed embodiments,

FIG. 3 shows a block diagram of the method according to the disclosed embodiments,

FIG. 4 shows the temperature-pressure curve of water during experimental process,

FIG. 5 shows basic view of a heat exchange system of a second embodiment of the system according to the disclosed embodiments, which utilizes two tanks,

FIG. 6 shows a phase diagram of NaOH during adiabatic pressure reduction,

FIG. 7a shows a side view of the first embodiment of tank and the actuator,

FIG. 7b shows a cross-section view of FIG. 7a,

FIG. 7c shows the enlargement of the detail A shown in FIG. 7b,

FIG. 8 shows the profile of the piston ring of the piston,

FIGS. 9a-9c show the piston sleeve used for the sealing of the piston,

FIGS. 10a and 10b show the outer sleeve used for sealing of the piston,

FIG. 11a shows the cross section of the second embodiment of the tank and the actuator side by side,

FIG. 11b shows the side view of the second embodiment of the tank and the actuator side by side,

FIGS. 12a-12e show the water piston and its parts used in the second embodiment.

In the drawings the following reference numerals are used:

| B | brine |
|---|---|
| F | feed liquid |
| H | heat exchange liquid |
| P | product water |
| 10 | system |
| 32 | actuator |
| 34 | wear ring |
| 38 | hydraulic connection line |
| 40 | tank |
| 75 | hydraulic cylinder |
| 75.1 | bottom of cylinder |
| 75.2 | piston rod |
| 76 | pressure accumulator |
| 77 | hydraulic control unit |
| 78 | position sensor |
| 79 | pressure pump |
| 80 | pressure control valve |
| 81 | hydraulic driven piston |
| 90 | piston |
| 91 | feed liquid tank |
| 92 | product liquid tank |
| 93 | brine tank |
| 94 | transfer pump |
| 95 | feed pump |
| 96 | conductivity sensor |
| 97 | flow sensor |
| 98 | 2-way valve |
| 99 | thermometer |
| 100 | 2-way valve |
| 101 | outlet valve |
| 102 | 4-way valve |
| 103 | proportional integral control |
| 104 | safety valve |
| 105 | drain valve |
| 108 | cylinder integrated heat element |
| 109 | heat exchange system |
| 110 | coolant liquid tank |
| 111 | heat exchanger |
| 112 | heating liquid tank, |
| 113 | pump |
| 114 | pump |
| 115 | heating element |
| 116 | software |
| 118 | piston ring groove |
| 120 | piston ring |
| 122 | metal edge |
| 124 | seal lip |
| 126 | outer sleeve |
| 127 | attachment flange |
| 128 | support corner |
| 129 | bolt hole |
| 130 | first groove |
| 131 | sleeve part |
| 132 | wear ring groove |
| 134 | piston sleeve |
| 136 | water cylinder |
| 140 | bleeding valve |
| 142 | hollow cavity |
| 144 | hydraulic valve unit |
| 146 | cooling coil |
| 148 | temperature sensor cover pipe |
| 150 | water piston |
| 152 | piston body |
| 154 | piston head |
| 156 | interior of the tank |
| 160 | domed head |
| 164 | thermometer cover |
| 165 | tank casing |
| 166 | support plate |
| 168 | support pipe |
| 170 | lower flange |
| 172 | upper flange |
| 174 | piston platform |
| 176 | piston guide |
| 178 | tank inlet |
| 180 | tank outlet. |

### DETAILED DESCRIPTION

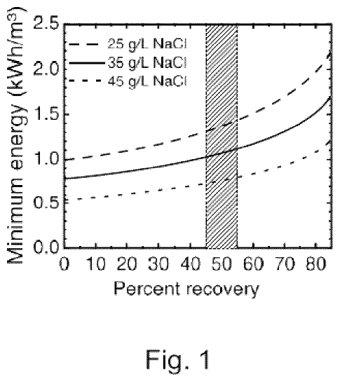

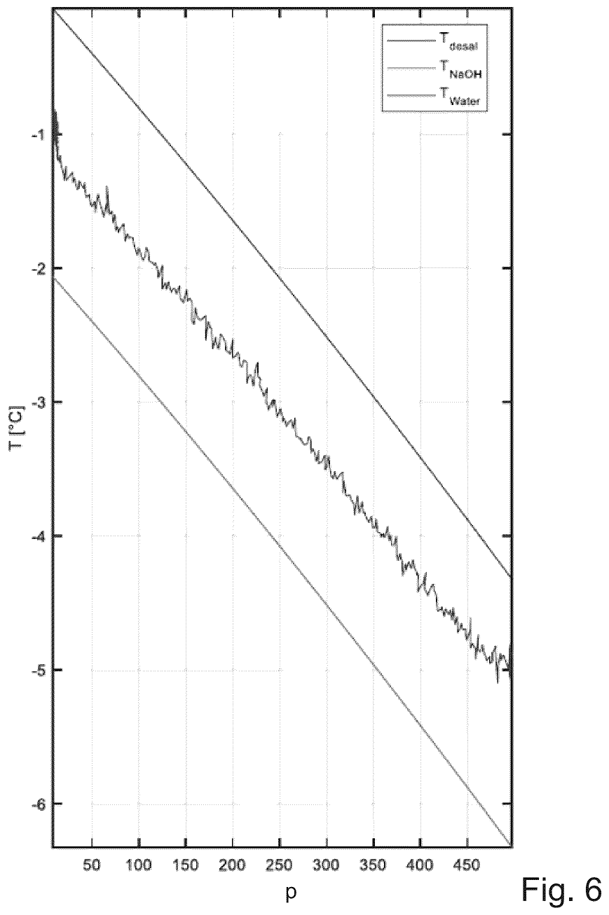

The working principals of the method and system according to the disclosed embodiments are described with respect to FIGS. 1-12e. All the description below uses water as product liquid in the embodiments, but it should be understood that other liquids besides water can also be used in the method. The expansion of water during freezing is an anomality specific to water whereas most other liquids tend to lose volume during freezing. However, substances such as silicon, gallium, germanium, antimony, bismuth and plutonium also expand during freezing.

From the preferably symmetry of the system follows that the pressure transfer is theoretically isentropic and reversible; however, the process involving the separation of pure water from a salt solution requires separation energy.

In practice there are sources of irreversibility. The compressibility of water decreases with pressure, being at 0° C. 52·10⁻⁶/bar at normal pressure and 39·10⁻⁶/bar at 2000 bar. The resulting distortion increases with the maximum pressure to a few percent at 2000 bar and must be compensated with external energy.

Also, friction, fluid viscosity and thermal losses must be compensated.

In addition to the pressure energy, it is also necessary to transfer the “cold”, i.e., heat energy, nearly reversibly between different stages.

The pressure used in the process is an obvious degree of freedom for optimization. The pressure energy is proportional to the square of the pressure while the yield of product water tends to grow proportionally to the pressure. The expense of the equipment grows rapidly towards the highest pressures, while the theoretical separation energy is lower at lower pressures due to lower salt concentration of the brine produced. The optimum pressure of this process is likely to be in the area of 600-1000 bar.

The total amount of water pressure energy to be transferred in the two pressurization-expansion processes is 48 MJ or 27 kWh per m3 of product water. It is assumed that the total reversibility of the four energy transfers is 90% amounting to an energy consumption of 2.7 kWh per m3 of product water. Adding the theoretical separation energy, 1 kWh/m³, and 0.5 kWh/m³ for losses elsewhere in the process, the total energy consumption would be 4.2 kWh/m³.

This process is also suitable for concentrating salts, radioactive materials, etc., present in various industrial, mining or waste waters.

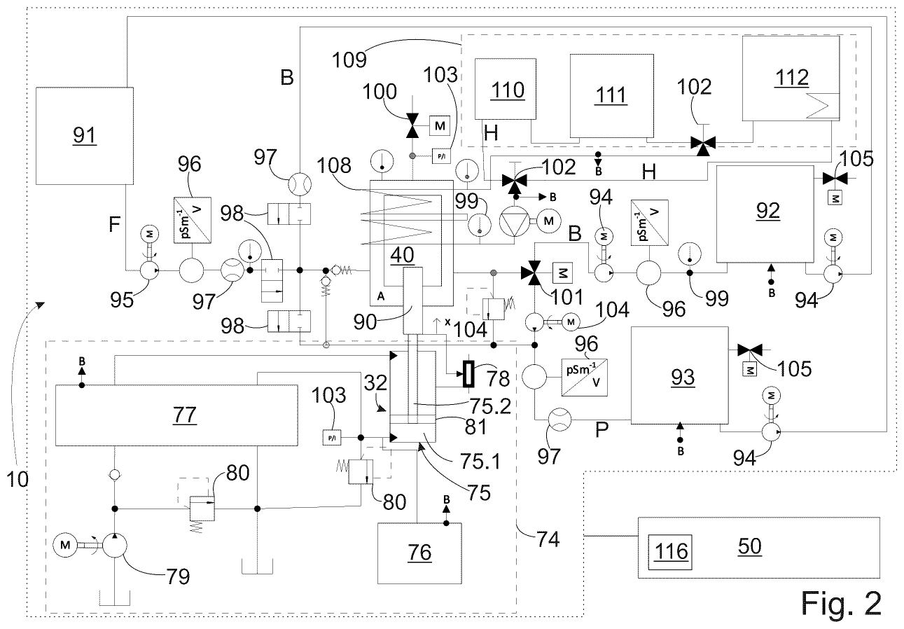

FIG. 2, showing a preferred embodiment. The system 10 is implemented using a hydraulic system to cause the adiabatic pressure change in the tank 40. The actuator 32 is operated with oil or water hydraulics, pneumatics, electric motor and mechanical screw/bar. The actuator using hydraulics consist of a hydraulic cylinder 75 and a pressure accumulator 76. The hydraulic cylinder and accumulator of the system are commercially available by for example Kashon Power.

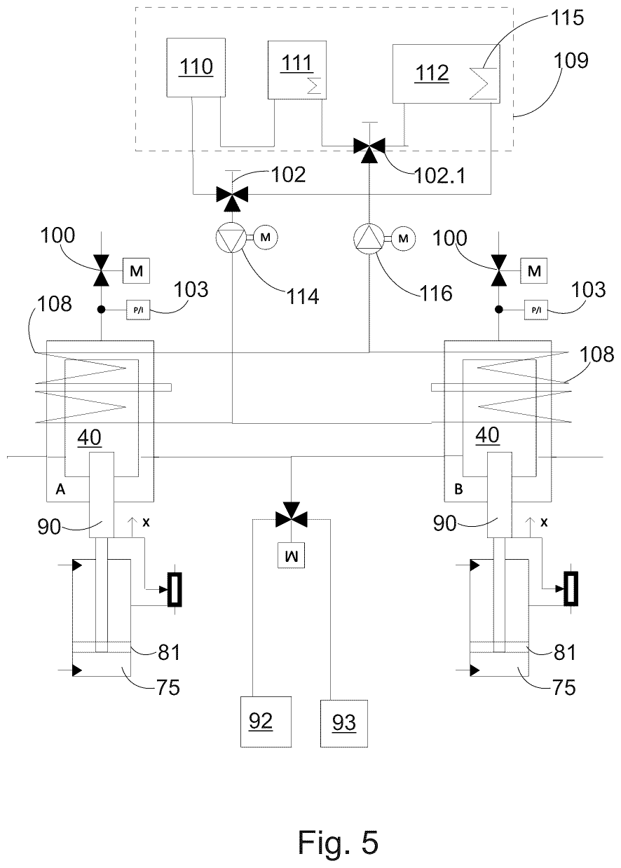

The embodiment shown in FIG. 2 discloses only one tank 40 which is preferably used for the desalination process. This is the simplest way of implementation. However, the system preferably includes at least one pair of tanks 40, as shown in FIG. 5, which are operated together to achieve the best possible efficiency. The two tanks preferably use adiabatically same integrated heat exchange system 109 including a heat exchanger 111, coolant liquid tank 110 and heating liquid tank 112, hydraulic control unit 77, 78, 79, 80 and control unit 50 with software 116. Also, a common brine tank 93 and product liquid tank 92 are used for both tanks 40.

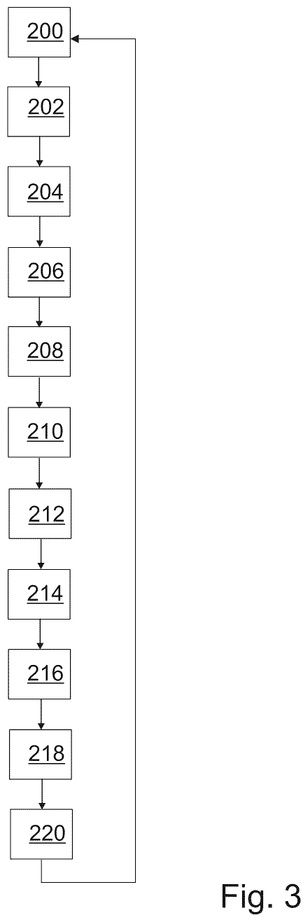

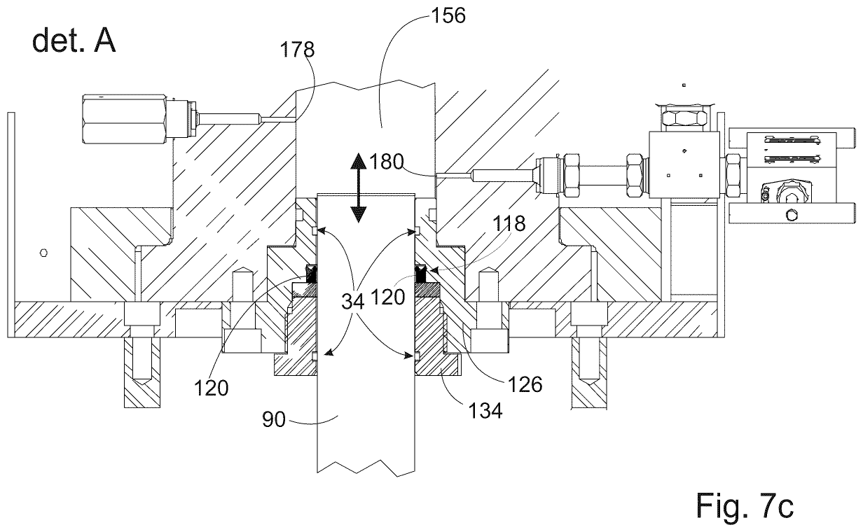

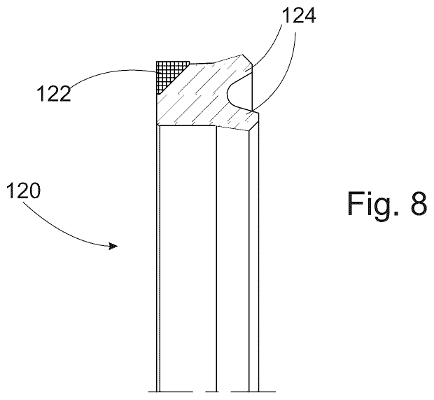

The method according to the disclosed embodiments comprises the following steps 200-220 disclosed in FIG. 3. Reference is made to FIGS. 2-6 as the method and the system according to the disclosed embodiments is explained in more detail. In phase 200, feed liquid F contained in feed liquid tank 91 is pumped to the process vessel, also known as the tank 40, using a feed pump 95. The feed liquid suitable for the method according to the disclosed embodiments is preferably filtered and solid material has been removed from it prior entry into the process. The inlet valve 98 is closed while the tank 40 is being filled with feed liquid F to the desired degree. In phase 202 the feed liquid F inside the tank 40 is pressurized using a piston 90 connected to a hydraulic actuator 74. The piston 90 can be implemented as in FIGS. 5 and 8 but is also possible to use a piston separate unit from the tank, that utilizes a water piston for transfer of pressure to the tank. As the pressure inside the tank 40 has reached a desired level, for example, 800-1500 bar, or preferably 600-1000 bar, the feed liquid F inside the tank 40 is cooled under pressure using heat exchanger 111 and cylinder integrated heat element 108 during phase 204. In other words, heat exchange liquid is circulated in the cylinder integrated heat element 108 to absorb heat from the feed liquid F, the temperature of which has increased during pressurization. The cooling is continued until the pressurized feed liquid F has reached a temperature near freezing. The cooling is not continued pass the point of freezing as it would not be energy efficient. In phase 206 the pressurized feed liquid F is expanded back to normal pressure causing a part of it to freeze. The freezing is preferably controlled by an algorithm that maintains the feed liquid in crystallization phase of freezing, i.e. as icy slush, not allowing it to fully freeze as solid ice. The expansion is caused by use of the piston 90 to increase the volume of the tank 40. Pure water of the feed liquid F is frozen during the adiabatic expansion and liquid brine B is formed.

In phase 208 the liquid brine B is removed from the tank 40 by opening a 3-way outlet valve 101 and pumping the brine to a brine tank 93 by using a transfer pump 94. In phase 210 the tank 40 is rinsed by pumping fresh water from a product liquid tank 92 using another transfer pump 94 while a 2-way valve 98 is opened and the outlet valve 101 is closed. Now the tank 40 contains a second mixture of fresh water P and pure ice. In phase 212 the mixture of fresh water P and pure ice in the tank 40 is pressurized using the piston 90 connected to the hydraulic actuator 74. As the pressure inside the tank 40 increases, the temperature of the second mixture increases causing the ice to melt. In phase 214 the pressurized fresh water in the tank is warmed using the heat exchanger 111 and the cylinder integrated heat element 108 just enough that when in phase 216 the fresh water in tank is expanded to normal pressure the fresh water does not freeze again. The expansion is caused using the cylinder to increase the volume of the tank. In phase 218 the fresh water P is removed to the product liquid tank 92 by opening valves the outlet valve 101 and a 2-way valve 100. In phase 220 the outlet valve 101 is closed which is the end of process cycle. Then all the previous phases 200-220 can be repeated.

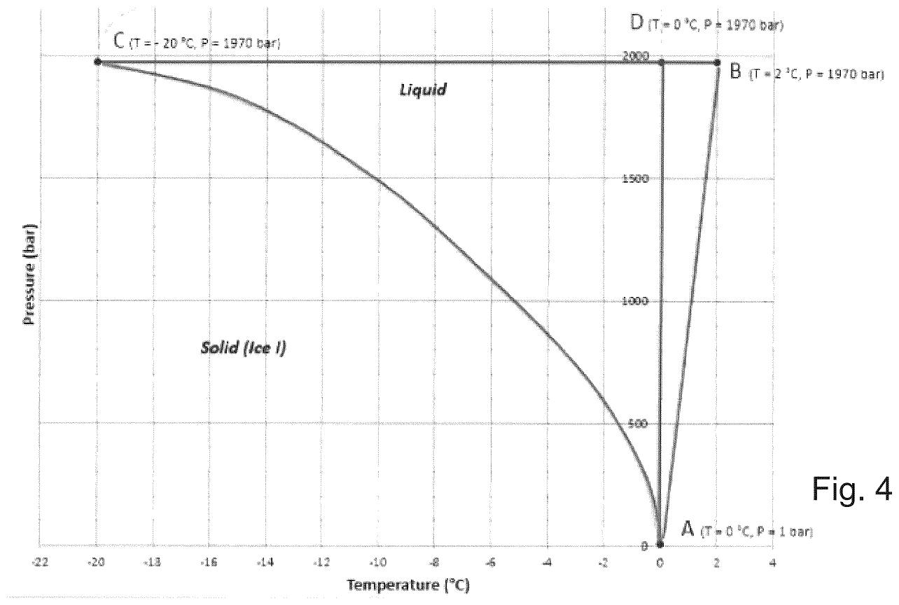

FIG. 4 shows the pressure and temperature changes during the desalination process as a diagram. The transition from point A to B is the compression of the feed liquid, during which the temperature of the feed liquid rises. The transition from point B to C is the heat exchange of cooling the feed liquid in high pressure. The transition from point C to A is the adiabatic expansion during which a mixture of pure ice and brine is formed. The brine is removed at point A as well as rinsing of the tank with fresh water. The pressurization of the second mixture of pure ice and fresh water takes place from point A to C during which the ice melts again. The cold pressurized fresh water can be used to cool down the pressurized feed liquid of another tank which is the transition from point C to D. The transition D to A is expansion of the fresh water back to normal pressure. Below is table 1 showing the energy needed for each action. It should be noted that heat needed for heating the fresh water is nearly the same as the heat recovered during cooling of the pressurized feed liquid. In addition, approximately half of the energy needed for compression can be recovered during expansion. Thus, the need for external energy in the process relatively small.

TABLE 1

| Step | Part of the process | Energy |
|---|---|---|
| 1-2 (line A-B) | compression | W₁₋₂ = 7.51 kJ/kg |
| 2-3 (line B-C) | heat exchange | Q₂₋₃ = 93.72 kJ/kg |
| 3-4 (line C-A) | expansion | W₃₋₄ = −10.12 kJ/kg |
| 4-5 (line A-C) | compression | W₄₋₅ = 10.12 kJ/kg |
| 5-6 (line C-D) | heat exchange | Q₅₋₆ = −85.20 kJ/kg |
| 6-7 (line D-A) | expansion | W₆₋₇ = −7.51 kJ/kg |

FIG. 5 shows the heat exchange system according to the preferred embodiment having two independent tanks 40. As can be seen from FIG. 5, the two tanks 40 share the heat exchange system 109 but also the product liquid tank 92 as well as the brine tank 93. As the feed liquid inside one tank 40 is cooled before expansion, the heat accumulated to the heat exchange liquid can be used pumped to the heating liquid tank 112. As the efficiency of the recovery of heat during cooling is 50% at best, the remainder of the heating can be done using a separate heating element 115 inside the heating liquid tank 112. Also, the cooled coolant liquid that is used for heating the second mixture of fresh water and pure ice is being collected to the coolant liquid tank 110, thus ensuring the thermal efficiency of the method.

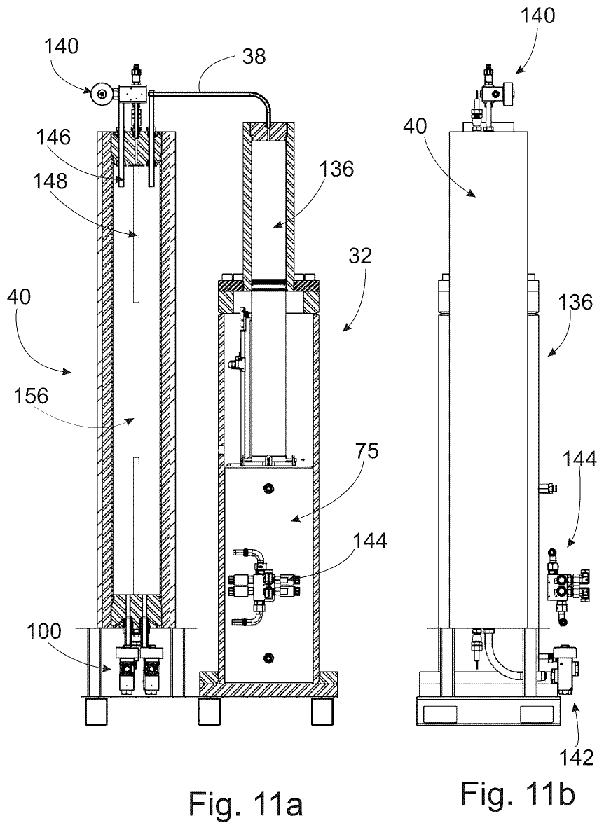

Cold heat transfer liquid is transferred from coolant liquid tank 110 via the 4-way valve 102 to the tank 40 on the left in FIG. 5 using the pump 114. The heat transfer liquid cools the feed liquid in the tank 40 and exits the cylinder integrated heat element 108 of the tank 40 at an elevated temperature. Then the heated heat exchange liquid is pumped using the pump 114 via the 4-way valve 102.1 to the heating liquid tank 112. The heat exchange liquid entering the heating liquid tank 112 is at a lower temperature than the heat exchange liquid in the heating liquid tank 112, thus cooling the content of the heating liquid tank 112. This cooling is compensated by using the separate heating element 115 to provide more heat. The heat exchange liquid from the heating liquid tank 112 is pumped the tank 40 on the right in FIG. 11 for heating the second mixture of fresh water and pure ice in the tank 40. As the second mixture is heated, the heat exchange liquid cools and is returned via pump 113 and 4-way valve 102 to the coolant liquid tank 110. As the heat exchange liquid entering the coolant liquid tank 110 is at a higher temperature than the heat exchange liquid in the coolant liquid tank 110, the temperature of the content of the coolant mixture tank 110 is elevated slightly. To cool the content of the coolant liquid tank 110, the heat exchange liquid in the coolant liquid tank is fed to the heat exchanger 111 wherein the heat of the heat exchange liquid is transferred to the heat exchange liquid from the heating liquid tank 112. The cooling of the coolant liquid in heat exchanger can be implemented, for example a heat pump or even cold temperature outside the facility if the climate is suitable.

Referring to back to FIG. 2, in addition to heat, it is also preferred to recover at least a part of the pressure that is being released during expansion. For this purpose, the system preferably includes a pressure accumulator 76, that is connected to the bottom of cylinder 75.1 to the opposite side of the hydraulic driven piston 81 in relation to the piston rod 75.2. Contrary to FIG. 2, the piston 90 may also form the piston rod 75.2 of the hydraulic cylinder. As the method is expansion phase, the hydraulic driven piston 81 is moved towards the end of the cylinder and hydraulic fluid is being led to the pressure accumulator 76, wherein a pressure is created. As the piston 90 is again being used for pressurization of the tank, the pressurized hydraulic fluid within the hydraulic accumulator can be led to the end of the cylinder 75.1 behind the hydraulic driven piston 81. In addition, the pressure pump 79 is used to compensate the pressure losses.

In the method according to the disclosed embodiments the brine is being collected into the brine tank 93 shown in FIG. 2. Since the brine is a valuable by-product of the method according to the disclosed embodiments, the concentration of the brine is preferably as high as possible. For increasing the concentration, the brine is preferably recycled back to the tank as a separate batch. Most preferably the brine is recycled 2-10 times so that the concentration of the brine is high for further processing. The efficiency of recovery of brine in each cycle of desalination is approximately 40-50%. The initial concentration of the brine in the mixture can be, for example, 2.5 wt %, whereas the desired concentration may be, for example 12, 5 wt %. The brine may be recycled using a transfer pump 94.

In addition to recycling of brine, the other product, i.e. fresh water is being recycled back to the tank when the tank is being rinsed. The rinsing of the tank is important if the purity of both products, the fresh water and brine is important. However, if fresh water is not used for further purposes, the rinsing is optional and may be left out.

The method and system according to the disclosed embodiments can be used for desalination of salty water, but also purification of industrial effluents having minerals and chemicals that are valuable. The freezing of salty water is known to follow the pressure drop constant according to known principles. However, industrial effluents, such as lime slurry is more difficult to predict. In some cases, the pressure drop causes the feed liquid to become subcooled before the formation of ice begins. Since the ice has a larger volume than the liquid form of the feed liquid, the pressure inside the tank increased due to freezing. To compensate the increase of volume caused by the freezing, the piston is utilized to increase the volume of the tank simultaneously. However, if the precise point of formation of the ice is not known, the automation of the system is hard to implement. For this reason, the system preferably includes a sensor 78 that is used to detect the formation of ice from the sudden increase of pressure inside the tank. As soon as the formation of ice is detected, the cylinder is used to compensate the volume change to maintain the desired rate of adiabatic expansion in the tank to form the mixture of pure ice and liquid brine. With the aid of the sensor 78, the system and the control of expansion can be automatized regardless of the feed liquid. The freezing takes place in a matter of seconds.

The system preferably includes a control computer used to control the operations of the valves, pumps, cylinder and other auxiliary devices of the desalination system. The control computer preferably includes software means configured for the control of the system based on various sensors shown in FIG. 2. In the system according to the disclosed embodiments only the tank and the lines leading up to the valves connected to the tank are subjected to high pressure, the other parts of the system are maintained in normal pressure. In this case, the normal pressure refers to atmospheric pressure. The method and system can also be implemented using slightly elevated pressure of 2-5 bar as a substitute for normal pressure. The volume of a single tank 40 can be 10-1000 l, for example 50 l. The tank can be made from high-strength steel or carbon-fiber composites or hybrid of both or other reinforced structure. The tank may be equipped with internal heat insulation to reduce heat transmission between the tank and its content during the desalination temperature cycles.

The tank is preferably made of two materials placed on top of each other, the inner material, that is in contact with the feed liquid, being preferably duplex. The purpose of the use of duplex is to create an inner surface that is highly corrosion resistant and can withstand the harsh conditions. Instead of duplex, the inner surface of the tank can also be made as a surface coating. However, the difficulty of using a coating is its durability in the difficult conditions. The outer material covering the inner material core can be carbon steel which is much cheaper than the inner material and provides adequate strength properties for the tank. The thickness of the tank can be 100-150 mm, of which 50-60 mm is carbon steel. A tank with a volume of 41 liters would then weight approximately 200 kg.

If pressures near the lower end of the operation range of the disclosed embodiments, namely pressures below 20 MPa are used, the outer material can also be some sort of composite structure.

The range of movement and the diameter of the piston define the displacement volume of the piston that needs to be proportional to the size of the tank. The piston is arranged to displace a volume of 1-20%, preferably 5-15% of the tanks volume.

FIG. 4 shows the desired bath of expansion when the feed liquid is water. The expansion rate and temperature must be held such that the freezing takes place in controlled manner so that the method can be automized. The automatization of the method is implemented using sensors to detect changes of pressure, volume, temperature and concentration as well as flow sensors. The sensors itself can be such known in the prior art for the particular purpose. The process control can be implemented using programmable PLC technology. The control algorithm is feed liquid sensitive, so that a separate control algorithm is used for each feed liquid. The process parameters are programmed to correspond to characteristics of the feed liquid in different concentrations. The control algorithm is designed to maintain the expansion of the desired bath specifically for each feed liquid.

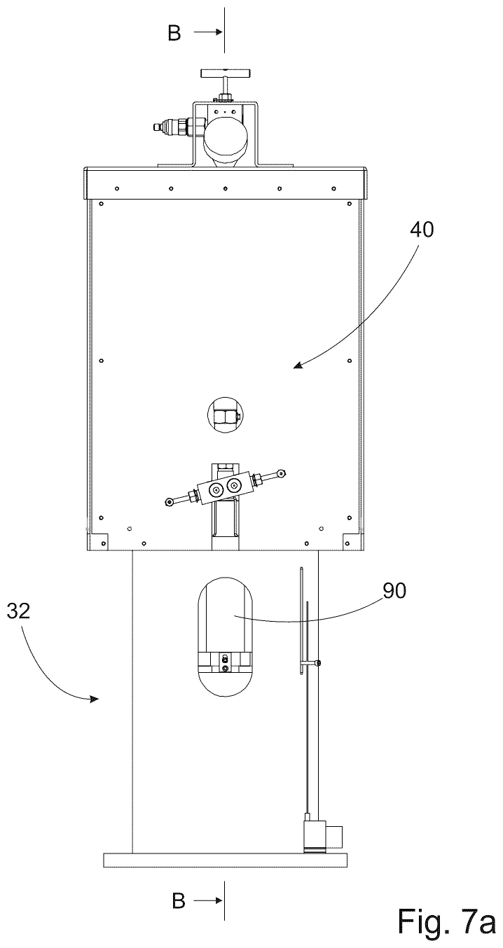

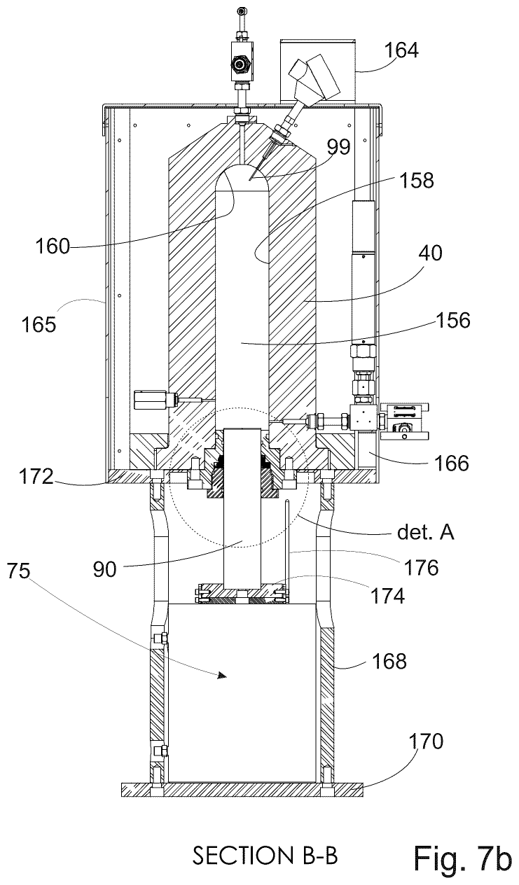

FIGS. 7a-12e show different embodiments for the implementation of the piston that causes the change of volume of the interior of the tank and the actuator that operates the piston. There are two embodiments, namely the first embodiment, wherein the actuator is attached directly to the tank, and the second embodiment wherein the actuator and the tank are placed side by side connected with a hydraulic connection line. With regards to the first embodiment, reference is made to FIGS. 2, 7a and 7b wherein the tank 40, piston 90 and the actuator 32 are all in line connected to each other. The second embodiment is shown in FIGS. 11a and 11b. In the second embodiment, the actuator 32, which is preferably a hydraulic cylinder 75, is located side by side with the tank 40, on the side of the tank 40.

### First Embodiment According to FIGS. 7a-10b

In the first embodiment, the actuator 32, which is preferably the hydraulic cylinder 75, is physically attached to the bottom of the tank 40 as shown in FIGS. 7a-7c. The actuator 32 operates the piston 90, which extends at least partially outside the tank 40. For this reason, the piston 90 must be supported on the tank 40. Alternatively, the actuator can also be attached on top of the tank, where it is only taking up space vertically, and thus not widening the area needed for the tank. However, it is preferred to attach the piston beneath the tank to facilitate bleeding of the hydraulic piston. A complete bleeding is essentially for the durability of the tank as any air mixed with feed liquid will collapse under the high pressure used in the method.

According to FIGS. 7a and 7b the tank 40 is preferably supported on a support pipe 168 inside of which is the actuator 32 that operates the piston 90. The support pipe 168 may be attached to the floor with using a lower flange 170 and to the tank 40 using an upper flange 172. In FIGS. 7a and 7b the actuator 32 is the hydraulic cylinder 75. The piston 90 enters the interior 156 of the tank 40 as shown in FIG. 7b and changes the volume of the interior 156. Preferably the interior 156 has a cylindrical part 158 with a domed head 160 which eliminates any sharp corners which would be weak spots. A thermometer 99 is preferably located in the domed head 160. The tank 40 may be inside a casing 165 and supported on the casing 165 by a support plate 166 surrounding the tank 40. The piston 90 may be fixed to a platform 174 which is connected to the hydraulic piston 75 shown better in FIG. 2. The platform 174 may be placed movably on a guide pin 176 that guides the platform 174 and the piston 90 upwards as the hydraulic cylinder 75 pushes the platform 174 up towards the tank 40.

FIG. 7c shows the enlargement of detail A shown in FIG. 7b. The system preferably includes at least two wear rings 34 located at distance from each other placed in between the piston 90 and the tank 40 for supporting the piston 90, and at least one piston ring 120 between the piston 90 and the tank 40 for sealing the piston 90. In FIG. 7c the piston ring 120 is preferably a ring seal. The cross-section view of the piston ring 120 is shown separately in FIG. 8 and the piston ring groove 118 reserved in the piston 90 for the piston ring 120 in FIG. 7c. The piston ring is preferably made of polymer that is suitable for the harsh pressure and temperature conditions. For example, a piston ring by American High Performance Seals, known as Duralast 4403, can be used in this purpose. This piston ring 120 includes a metal edge 122 connected to the polymer piston ring which has two seal lips 124 place apart from each other in the longitudinal direction of the piston. The purpose of the metal edge is to make the piston ring piston ring more rigid and to lock the piston ring in place. The two lips of the piston ring enable perfect sealing even with high pressures used inside the tank.

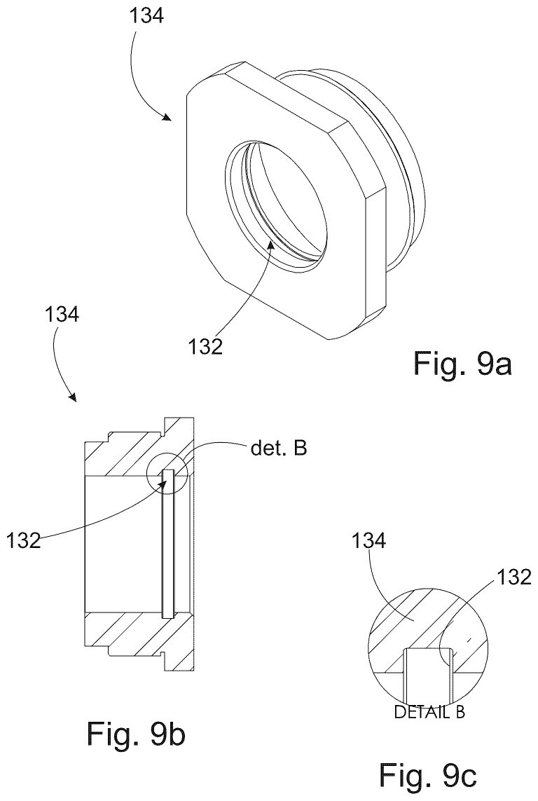

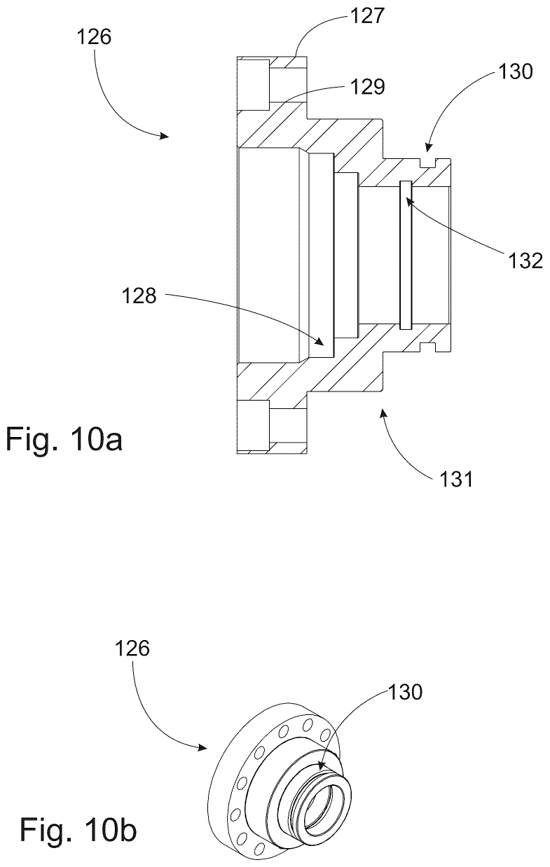

The wear rings and the piston ring can be placed in between the piston and the tank in two alternative embodiments. In one embodiment the necessary grooves for the wear rings and piston ring are fabricated directly to the tank. However, this is quite difficult to implement as the machining of the grooves to the tank is difficult. In the other, prefer embodiment, the grooves, wear rings and the piston ring are formed to separate sleeve or sleeves attached in between the tank and the piston or the piston rod, whichever enters the interior of the tank. However, the grooves for wear rings and the piston ring are difficult to machine into a single sleeve, and for that reason, in the preferred embodiment there are two separate sleeves, namely the piston sleeve 134 shown in FIGS. 7c, 9a-9c and the outer sleeve 126 shown in FIGS. 7c, 10a and 10b. It must be noted that the tolerance for machining the grooves for wear rings and the piston ring is small and therefore it requires high precision machining. According to FIG. 7c one of the wear rings 34 is placed on a piston sleeve 134, which is placed around the piston 90 or the piston rod attached to the piston. The piston 90 or the piston rod moves in relation to the piston sleeve 134 which is stationary and fixedly attached to the tank 40 via the outer sleeve 126, shown in FIG. 7c. Both piston sleeve 134 and the outer sleeve 126 are stationary in relation to the tank 40, whereas the piston 90 moves concentrically in relation to these parts. According to FIG. 7c, the piston ring 120 is placed in between the piston 90 and the outer sleeve 126 which is placed partly inside the tank 40.

The outer sleeve shown in FIGS. 10a and 10b includes first groove 130 for a static seal, that seals the outer sleeve 126 to the tank. The outer sleeve 126 includes an attachment flange 127 equipped with bolt holes 129 for attaching the outer sleeve 126 to the tank 40 as shown in FIG. 16. A sleeve part 131 is attached to the attachment flange 127 and extends towards the interior of the tank 40. The sleeve part 131 has two separate diameters, the larger diameter part being sunk into the outer layer of the tank and the smaller diameter part extending into the interior of the tank. The structure with two diameters enables better sealing. The smaller diameter part of the sleeve part 131 preferably has a wear ring groove 132 for a wear ring 34 shown in FIG. 7c which is supporting the piston 70 or the piston shaft in correct alignment. A second wear ring 34 is installed in the wear ring groove 132 of the piston sleeve 134 shown in FIGS. 9a-9c. The piston sleeve 134 is inserted inside the outer sleeve 126 as shown in FIG. 7c. Preferably the piston sleeve and the outer sleeve are machined to such high level of precision that they fit each other with a tolerance of only 0.01-0.1 mm.

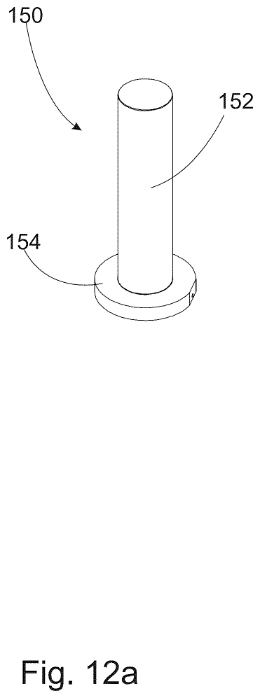

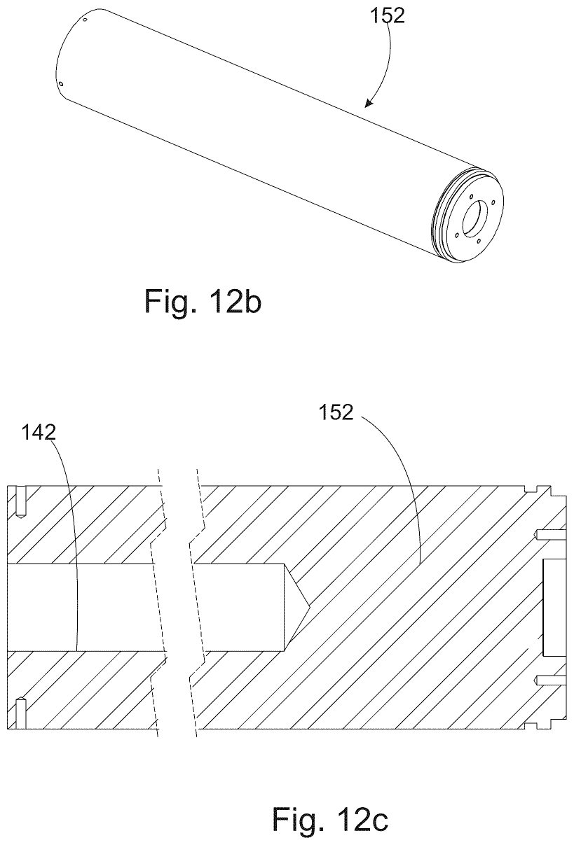

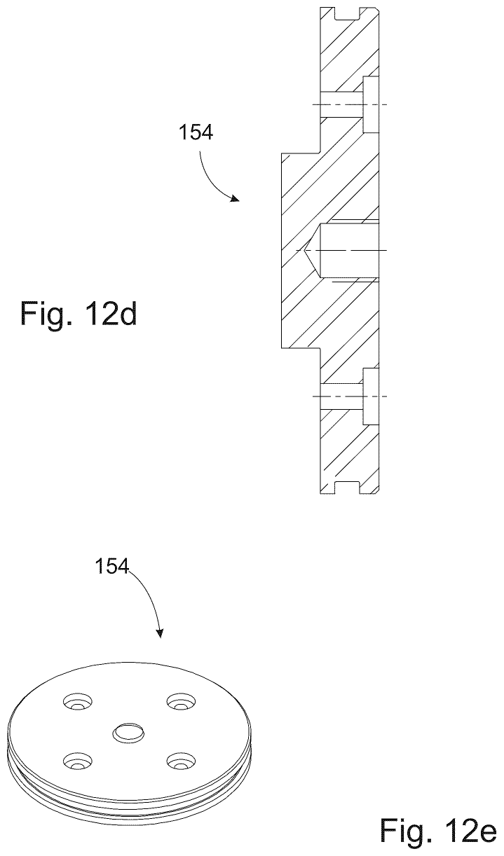

### The Second Embodiment Shown in FIGS. 11a-12e

The second embodiment, wherein the actuator 32 and the tank 40 are placed side by side connected with a hydraulic connection line 38, is shown in FIGS. 11a and 11b. In this embodiment, the actuator 32 is preferably a combination of hydraulic cylinder 75 and a water cylinder 136. The water cylinder 136 is connected to the hydraulic cylinder 75 and is connected to the hydraulic connection line 38 which is connected to the tank 40. In other words, the interior of the water cylinder 136 and the hydraulic connection line 38 together with interior 156 of the tank 40 form a uniform volume for the feed liquid. A major advantage of this embodiment is the smaller height of the equipment, which is important if the tanks are in a mobile facility, such as a standard freight container wherein the space is for the system is very limited. The standard dimension of the freight container does not allow the first embodiment of the tank to be installed in vertical position and the bleeding of a horizontally positioned tank would be difficult. By using the implementation of the second embodiment, it is possible to create achieve production capacity of 700 m³/d within one freight container having the maximum weight of 23 000 kg. If production capacity of over 1000 m³/d is needed, it is preferred to use the implementation of the first embodiment in a separate production facility, since it is easier to control the production using smaller number of tanks rather than a larger number of smaller tanks.

It is also possible to implement the second embodiment using an electric motor as the actuator combined to the water cylinder. However, the electric motor is used in combination with a gearing to convert the movement speed of the electric motor to increase torque does not allow the piston to move away from the tank as the pressure increases during freezing of the feed liquid like a hydraulic cylinder does. Therefore, the control of the electric motor must be more precise to compensate the increase in pressure caused by the freezing of feed liquid.

A water piston 150 used in the water cylinder is shown separately in FIG. 12a, and it consists of a piston body 152, shown separately in FIGS. 12b and 12c, and a piston head 154, shown separately in FIGS. 12d and 12e. The piston head is preferably removably attached to the piston body 152 so that a rigid piston ring can be fitted around the piston rod. In addition, the implementation of the water piston 150 in two parts enables easier handling of the water piston before installation as the complete water piston can be heavy, even over 200 kg. The hydraulic cylinder is driving the water piston 150 that pressurizes the feed liquid inside the connection line and tank. The movement of the piston may be 200-1000, preferably 300-700 mm. The diameter of the piston may be 30-200 mm, preferably 50-150 mm. The dimensions of the hydraulic piston inside the hydraulic cylinder must be selected so that the desired pressure levels can be achieved. The piston may be made of duplex with a carbon steel core. The piston can also be hollow to reduce the weight of the piston which would otherwise be very heavy.

### The Control of Freezing

The control unit with software and digital hydraulic control unit both control the different stages of the process by following the input data provided by sensors and meters.

The input data provides information about the different stages of the process for use by the software of the control unit and thus for controlling the process. The information obtained from the inputs may include information such as valve position, fluid flow rate, pressure, temperature, piston stroke length, volume, fluid conductivity, fluid density and activity coefficient.

The digital hydraulic control unit is used in different stages of the process:
during feeding of feed liquid to the tank, at least one or more of the following is monitored: flow rate, temperature or water conductivity of the feed liquid; for controlling and monitoring one or more of the following: amount, quality, process temperatures of the feed liquid.
during pressurization of the feed liquid in the tank, at least one or more of the following is monitored: piston stroke length, volume, temperature, pressure; for controlling and managing of volume changes or freezing of the feed liquid or both,
during expansion, digital hydraulics are controlling the formation of freezing and composition at a desired controlled rate while maintaining separation of brine and product so that brine is in as pure a form as possible,
during expansion, digital hydraulics use sensor information including one or more of the following: piston stroke length, volume, fluid conductivity, fluid density, activity coefficient; for control,
during removal second mixture, one or more of the following is monitored: flow rate, temperature, fluid conductivity, density; for enabling control of one or more of the following: fluid quantity, quality, composition; and thus management of controlled separation by optimal and adjustable way,
digital hydraulic unit can also be connected to heat exchange control.

1.-15. (canceled)

16. A system for purification of feed liquid, the feed liquid containing minerals or chemicals or both, the system comprising
a tank for the feed liquid to be used with a high pressure of 5-200 MPa;
a feed pump for feeding the feed liquid into the tank;
a piston in connection with the tank for affecting volume of the tank to pressurize and depressurize the tank alternatively to pressurize the feed liquid in the tank to the high pressure and to expand the feed liquid adiabatically in the tank to essentially normal pressure causing at least a part of the feed liquid in the tank to freeze forming a mixture of ice and liquid brine, wherein the piston is arranged to adiabatically pressurize the tank for melting the ice, the piston extending at least partially outside the tank;
an actuator attached to the piston, the actuator being located outside the tank for pushing and pulling the piston;
a heat exchange system with heat transfer liquid arranged in connection with the tank for alternatively cooling the feed liquid at high pressure in the tank and heating a second mixture of ice and liquid product in the tank using the heat transfer liquid;
an outlet valve for removing the liquid brine and product water alternatively from the tank;
a brine tank for recovering the brine;
a product liquid tank for recovering the liquid product; and
a transfer pump for recycling product water from the product liquid tank into the tank forming a second mixture of ice and product water.

17. The system according to claim 16, wherein the system further includes
two wear rings located at distance from each other placed in between the piston and the tank for supporting the piston; and
at least one piston ring around the piston for sealing the piston.

18. The system according to claim 17, wherein the system includes a piston sleeve and an outer sleeve placed concentrically relative to each other between the piston and the tank, and each of the piston sleeve and the outer sleeve having one of the wear rings.

19. The system according to claim 16, wherein the system further includes
a sensor for detecting the formation of ice based on pressure change in the tank during expansion; and
a software for driving the piston to compensate the pressure change caused by the forming of ice.

20. Method for purification of feed liquid using the system according to claim 16, the feed liquid containing minerals or chemicals or both, the method having in the following order the followings steps of:
A) feeding feed liquid into the tank;
B) pressurizing the feed liquid in the tank to a high pressure of 5-200 MPa by using the piston extending partially outside the tank, the piston affecting the volume of the tank;
C) cooling the feed liquid at high pressure using heat transfer liquid to temperature near freezing point under the high pressure;
D) expanding the feed liquid adiabatically in the tank to essentially normal pressure by using the piston causing at least a part of the feed liquid to freeze forming a mixture of ice and liquid brine;
E) removing the liquid brine from the tank;
F) collecting brine to the brine tank;
G) forming a second mixture of ice and liquid in the tank;
H) pressurizing the second mixture adiabatically to the high pressure by using the piston causing the ice to melt;
I) using the second mixture to cool another portion of pressurized feed liquid under the high pressure thus expanding the second mixture adiabatically to essentially normal pressure by using the piston;
J) removing the second mixture from the tank as the product liquid;
wherein the liquid in the second mixture is product liquid recycled back to the tank.

21. The method according to claim 20, wherein the method further includes a step of collecting the pressure energy during expansion in the tank into a pressure accumulator using the piston connected to the pressure accumulator.

22. The method according to claim 20, wherein the method further includes a step of detecting the formation of ice by a sensor based on the pressure change in the tank during expansion and using the software to drive the piston to compensate the change of pressure caused by the forming of ice in the tank.

23. The method according to claim 20, wherein the method further includes a step of introducing a freezing initiation impulse of at a beginning of expansion of the cooled and pressurized feed liquid to initiate the freezing of the feed liquid.

24. The method according to claim 23, wherein the freezing initiation impulse is created by feeding cold inside the tank.

25. The method according to claim 20, wherein the adiabatic expansion of the feed liquid in the tank is controlled using a control algorithm to control the rate of formation of the mixture of ice and liquid brine while maintaining separation of ice and liquid brine so that the formed ice is in as pure as possible.

26. The method according to claim 25, wherein during expansion, the control algorithm is arranged to control the freezing of feed liquid and composition at a desired controlled rate while maintaining separation of brine and product so that brine is in as pure a form as possible while remaining at crystallization phase using sensor information including one or more of the following: piston stroke length, tank volume, fluid conductivity, fluid density, activity coefficient; for control.

27. The method according to claim 25, wherein the control algorithm
uses a sensor to monitor information including one or more of the following: piston stroke length, volume, fluid conductivity, fluid density, activity coefficient; and based on the information
controls movement of the piston during expansion to maintain the crystallization of the feed liquid within ±30% range of the temperature and pressure of the eutectic point of the feed liquid.

28. The method according to claim 25, wherein the control algorithm maintains the feed liquid in liquid crystallization phase of freezing while the piston is moving until the movement of the piston stops when the ice is formed.
